(19) United States
(12) Patent Application Publication
(10) Pub. No.: US 2014/0133953 A1
(43) Pub. Date: May 15, 2014

(54) Battery Case and Method of Changing Batteries with a Fork Lift Truck

(71) Applicant: ENERGY PRODUCTS INC., Sterling Heights, MI (US)

(72) Inventor: Kurt H. Smith, Birmingham, MI (US)

(73) Assignee: Energy Products Inc., Sterling Heights, MI (US)

(21) Appl. No.: 13/673,433

(22) Filed: Nov. 9, 2012

(51) Int. Cl. B65G 67/04; H01M 2/10; B66F 9/18; H02J 7/00

(52) U.S. Cl. CPC B65G 67/04; H02J 7/00; H01M 2/10; B66F 9/18
USPC 414/809; 320/107; 429/99; 187/237

(57) ABSTRACT

An industrial truck battery assembly includes a case that defines an upper opening that is covered by a lid. The lid defines at least one lift truck fork pocket and is assembled to the housing to span the upper opening. A method is disclosed for providing a plurality of charged batteries on a trailer to a facility that uses batteries for a plurality of industrial trucks. The batteries on the trailer are charged out-of-doors at a remote charging location and the trailer with the charged batteries is returned to the facility. The battery charging facility may comprise a plurality of battery chargers disposed inside a van trailer. A tine for the battery assembly has a distal end that includes a stop.

### TECHNICAL FIELD

A battery case for an industrial lift truck battery and a method of providing charged batteries to a facility that are exchanged for discharged batteries.

### BACKGROUND

Battery powered industrial trucks and industrial material handling machines that have a battery that supplies power to the industrial truck. The battery must be either recharged or provided with a replacement battery when insufficient reserve power is available for truck operation.

Facilities that have industrial trucks and material handling machines that have replaceable batteries generally have a battery replacement area that is staffed with a maintenance worker whose job it is to replace batteries. Replaceable batteries are generally lifted by a crane that is attached to the batteries by cables or a chain to remove and replace the batteries. With this approach, floor space is required to store, recharge, remove and replace the batteries. Truck operators generally stand by while their battery is exchanged for a charged battery by the maintenance worker who changes the battery. The maintenance worker may attend to charging the discharged batteries or other tasks when there are no batteries to change.

Applicant previously offered a charged battery delivery service in which a crane was used to remove and replace batteries that were charged in a remote battery charging building. The batteries were delivered on a conventional flatbed trailer that was unloaded and loaded from a truck well dock. While this approach reduced the floor space required for battery charging, a crane and truck well were required to load and unload the batteries. A crane operator was also required to load and unload the batteries.

This patent application was prepared with knowledge of the following patents and publications: U.S. Pat. No. 5,545,967; U.S. Pat. No. 6,094,028; U.S. Published Patent Application No. 2009/0139940; German patent application No. DE102006032733 A1; and Japanese Patent Application No. JP11228086 A2.

The above problems and challenges are addressed by this disclosure as summarized below.

### SUMMARY

According to one aspect of this disclosure, an industrial truck battery assembly is provided that includes a plurality of batteries and a case that houses the batteries. The battery case that defines an upper opening that is covered by a lid. The lid defines at least one lift truck fork pocket and is assembled to the housing to span the upper opening.

According to other aspects of this disclosure relating to the batter assembly, the lid may include a first part that defines a first lift truck fork pocket and a second part that defines a second lift truck fork pocket. The first part and the second part may be fixedly connected to each other. The lid may include a first pivot connector on a first side of the housing and a second pivot connector on a second side of the housing. The first pivot connector and the second pivot connector may be selectively removed from the first part and the second part to provide access to the batteries through the upper opening. The first pivot connector may be removed from the lid and the first side of the housing to pivot about the second pivot connector.

The lid may define a plurality of ventilation holes that provide air flow to the batteries. The lift truck fork pocket may define a plurality of visual observation openings in a top wall of the lid.

According to another aspect of this disclosure, a method is disclosed for providing a plurality of batteries on a trailer to a facility that uses batteries for a plurality of industrial trucks. The method comprises the steps of charging the plurality of batteries on the trailer at a remote charging location and delivering the trailer with the charged batteries to the facility. The charged batteries on the trailer are installed in the industrial trucks and the trailer is loaded with discharged batteries from the industrial trucks with a fork lift truck. The trailer with the discharged batteries is then transported to the remote charging location.

According to other aspects of this disclosure as it relates to a method of providing charged batteries, the remote location may be an outdoor charging facility where the trailer takes the batteries to be charged without removing the discharged batteries from the trailer. The trailer may include a plurality of charging connectors with one charging connector being provided for each of the plurality of discharged batteries and a plurality of charging receptacle adapters being provided to connect each of the discharged batteries to a battery charging system. According to the method, the battery charging system may provide electrical energy from a power grid or from a power generator.

According to other aspects of this disclosure as it relates to the method of providing charged batteries, during the installing step and the loading step the batteries may be loaded on to the trailer in a single row so the fork lift truck can perform the installing step and the loading step from the right side of the trailer or the left side of the trailer. The trailer may have a rack that is attached to the trailer for receiving the batteries. The width of the trailer and the width of the rack may be approximately the same as the width of the batteries. The rack may have an upper set of battery receiving areas that receive a top row of batteries and a lower set of battery receiving areas that receive a bottom row of batteries. The upper set of battery receiving areas and a lower set of battery receiving areas may define a recess that confines the batteries within the battery receiving areas.

The batteries may include a housing that defines a fork pocket that extends through the housing. The fork lift truck may have at least one tine that has a retainer lip on a distal end of the tine that is inserted fully through the fork pocket to facilitate retaining the battery on the tine.

According to another aspect of this disclosure, a battery charging facility is provided for charging a plurality of discharged battery assemblies for industrial trucks and material handling machines. The battery assemblies are retained on a trailer and the battery charging facility comprises a plurality of battery chargers disposed inside a van trailer that has a plurality of charger connectors. A plurality of docking stations may be spaced along the van trailer where the trailers used to transport the batteries are received for charging. A set of battery connectors are electrically connectable to the plurality of discharged batteries on the trailer. As an alternative, the battery chargers may be provided on a truck receiving doack.

According to other aspects of this disclosure relating to the battery charging facility, the dock may be located out-of-doors and the trailers when received at the docking station may remain out-of-doors. The source of electrical power may include either or both of a power grid and a power generator.

According to another aspect of this disclosure, a tine is provided for a fork lift truck that has a battery assembly defining a fork pocket. The fork lift truck has a mast and a tine support structure that receives a support end of the tine that is attached to the tine support structure. A distal end of the tine includes a stop that extends upwardly from a top surface of the tine for retaining a battery on the tine when the tine is inserted through the fork pocket of the battery. The stop may include a tapered end at the distal end of the tine. A vertical wall may be provided that extends upwardly from the top surface of the tine and faces the support end of the tine. The tine may have a general taper in a vertical direction with a greater thickness at the support end and a reduced thickness at the distal end.

These and other aspects of this disclosure will be described in greater detail in the following detailed description of the illustrated embodiments with reference to the attached drawings.

### BRIEF DESCRIPTION OF THE DRAWINGS

FIG. 1 is a diagrammatic elevation view of a low boy trailer including a plurality of batteries in racks at a remote charging station that in the illustrated embodiment is housed within a van trailer.

FIG. 2 is a top plan view of the low boy trailer and van trailer shown in FIG. 1.

FIG. 3 is a perspective view of a large capacity industrial truck battery.

FIG. 4 is a front elevation view of the battery shown in FIG. 3.

FIG. 5 is a side elevation view of the battery shown in FIG. 3.

FIG. 6 is a perspective view of a small capacity industrial truck battery.

FIG. 7 is a front elevation view of the battery shown in FIG. 6.

FIG. 8 is a side elevation view of the battery shown in FIG. 6.

FIG. 9 is a side elevation view of a set of lift truck forks especially adapted to lift and transfer an industrial truck battery that is shown in phantom.

FIG. 10 is a perspective view of the industrial lift truck tine assembled to a supporting structure.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

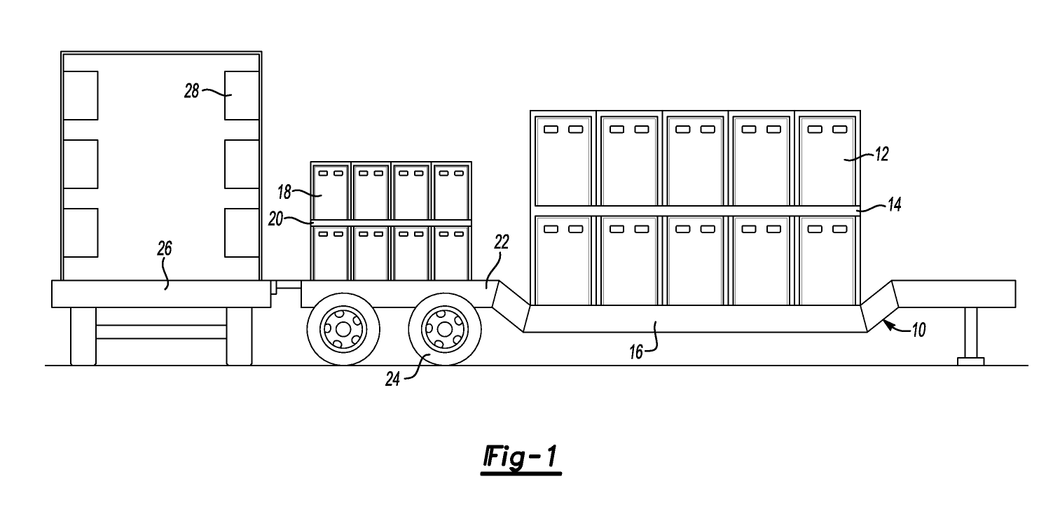

Referring to FIG. 1, a lowboy trailer 10 is shown with a load of high capacity batteries 12 disposed in a battery rack 14. The battery rack 14 is secured in the lower height section 16 of the lowboy trailer 10 to facilitate loading and unloading the batteries 12 with a fork truck (not shown) that may be operated at floor level. A plurality of low capacity batteries 18 are retained in a battery rack 20 on a raised height section 22 of the lowboy trailer 10. The low capacity batteries 18 are smaller and the battery rack 20 has a lower overall height than the battery rack 14. The raised height section 22 of the lowboy trailer 10 is disposed over the wheels 24 of the lowboy trailer 10. The lowboy trailer 10 is shown next to a van trailer 26 that is provided with a plurality of battery chargers 28.

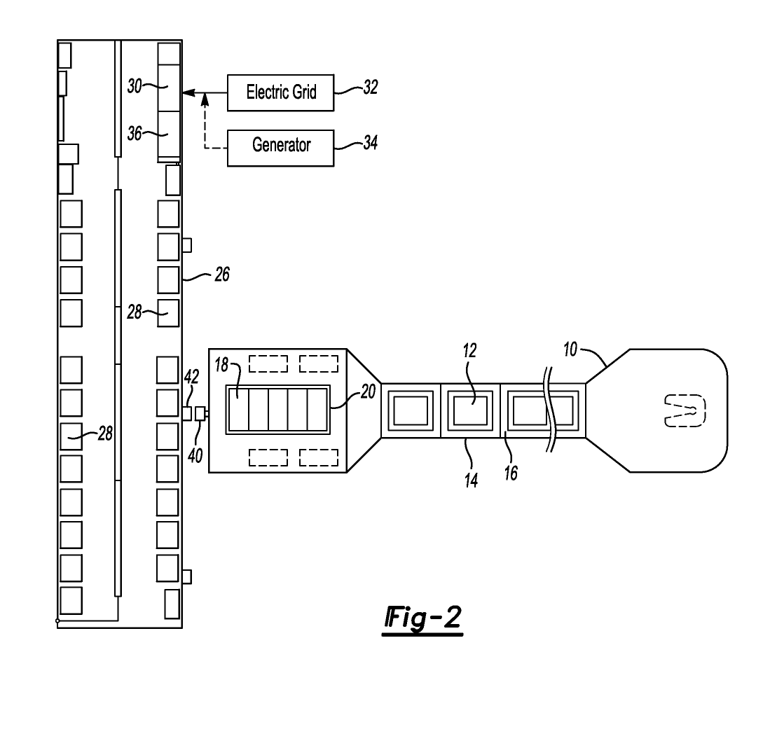

Referring to FIG. 2, the lowboy trailer 10 is shown with the high capacity batteries 12 in a battery rack 14 secured to the lower height section 16 of the lowboy trailer 10. The lower height section 16 may be of a reduced width to facilitate loading and unloading the high capacity batteries 10 into the battery rack 14 from either the right or left side of the lowboy trailer 10. The low capacity batteries 18 are disposed in the battery rack 20 on the raised height section 22 of the lowboy trailer 10. The lowboy trailer 10 is backed into close proximity with the van trailer 26 to charge the batteries 12, 18.

The van trailer 26 houses the plurality of battery chargers 28 that may be aligned along the walls of the van trailer 26. The van trailer 26 also houses a main electrical panel 30 through with the van trailer 26 may be connected to the electrical power grid 32. Alternatively, if there is a failure in the electrical power grid 32, a generator 34 may be used to provide power to the battery charges 28. A charger power distribution interface 36 is used to connect the main electrical panel 30 with the battery chargers 28 through cables or bus connections. A battery cable connector 40 is used to connect the batteries 12, 18 to a charger network receptacle 42. A plurality of charger network receptacles 42 are provided on the van trailer 26 to permit a plurality of lowboy trailers 10 to be connected for charging at the same time.

The width of the lowboy trailer 10 in the lower height section 16 may be reduced to substantially the same width as the high capacity batteries 12 and the battery rack 14. As used herein, the term substantially the same width in this context means within a foot of the width of the battery pack 14.

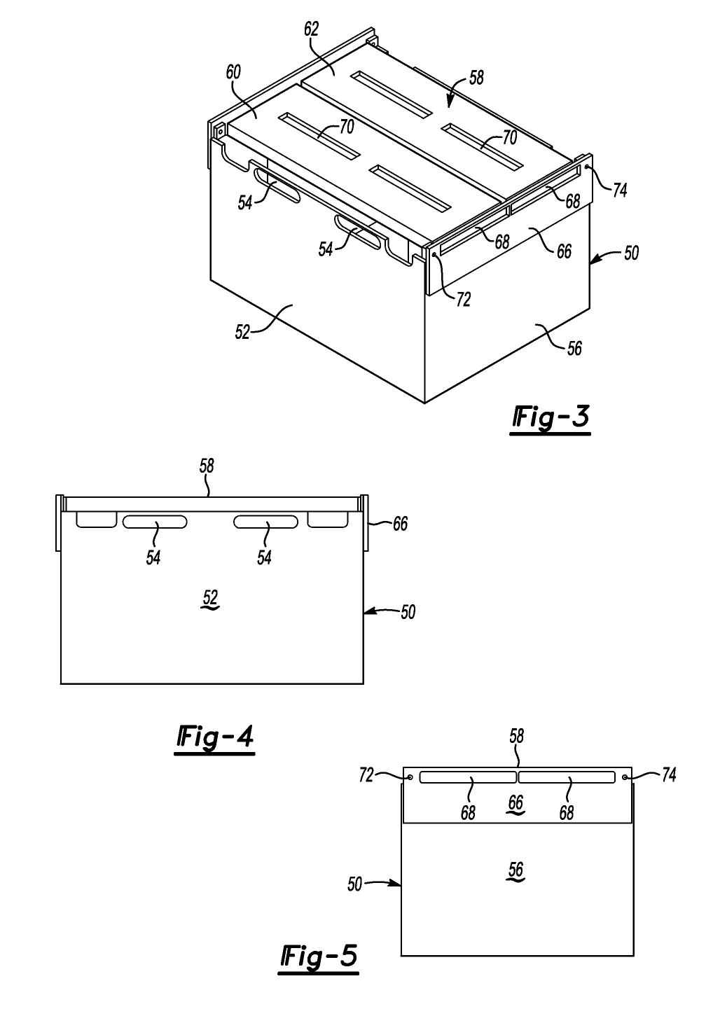

Referring to FIGS. 3-5, a high capacity battery case 50 is illustrated that includes a front wall 52. A plurality of ventilation ports 54 may be provided in front wall 52. A side wall 56 of the battery case 50 is provided on both sides of the battery case 50. A rear wheel not shown is provided on the battery case 50 opposite the front wall 52. A lid 58 is connected to the top of the battery case 50. The lid 58 provides a first fork pocket 60 and a second fork pocket 62 in which the forks of an industrial lift truck may be inserted to load and unload the battery case 50 in the battery rack 14. The lid 58 includes a side wall 66 on both sides of the case 50. A pair of fork pocket openings 68 is provided in a lid sidewall 66 that opens into the first fork pocket 60 and the second fork pocket 62, respectively.

A plurality of observation slots 70, or openings, are provided in the top of the first fork pocket 60 and the second fork pocket 62 so that an industrial lift truck operator may observe the extent to which the industrial fork lift truck (not shown) extends through the length of the fork pocket 60, 62.

A first pivot connector 72 and a second pivot connector 74 connect the lid 58 to the side walls 56 of the battery case 50. Either or both of the pivot connectors 72, 74 may be removed. If a first pivot connector 72 is removed, the lid 58 may be pivoted about the second pivot connector 74 to provide access to the batteries contained within the battery case 50. Alternatively, the second pivot connector 74 may be removed and the lid 58 may be pivoted about the first pivot connector 72. If it is desired to remove the lid 58 completely, both the first pivot connector 72 and the second pivot connector 74 may be removed and the lid 58 may be lifted off of the battery case 50.

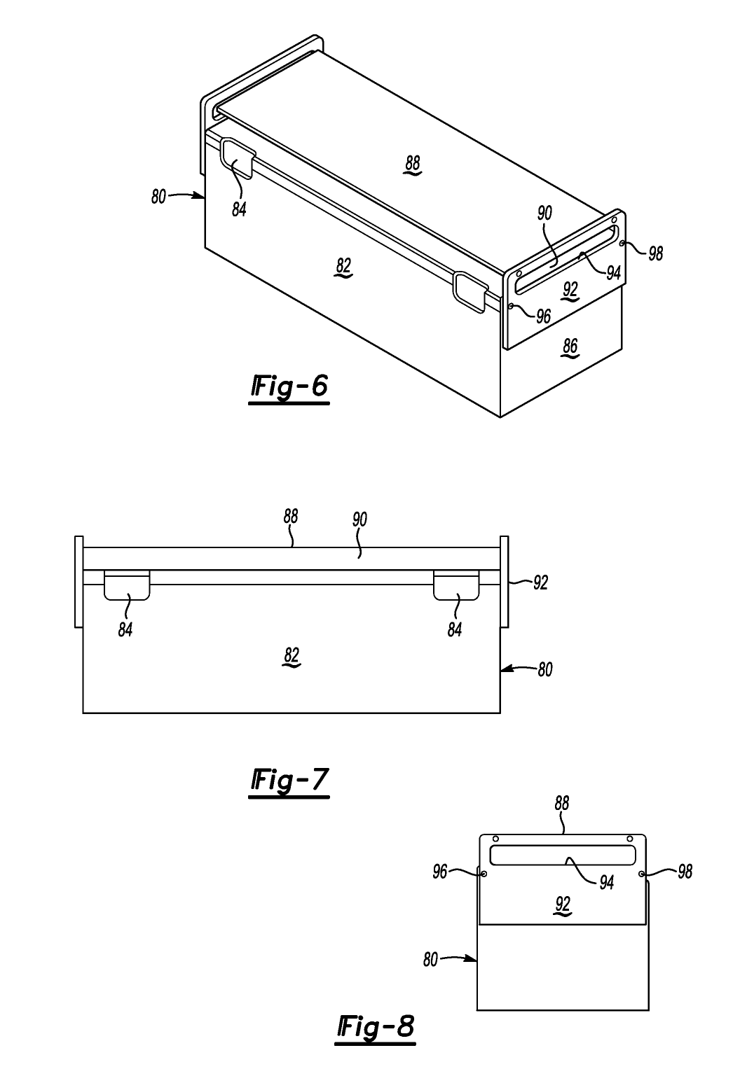

Referring to FIGS. 6-8, a low capacity battery case 80 is shown to include a front wall 82 that includes ventilation ports 84. A side wall 86 is illustrated as part of the low capacity battery case 80. A lid 88 is assembled to the top of the battery case 80 and defines a single fork pocket 90. A lid side wall 92 is provided as part of the lid 88. The lid side wall 92 defines a fork pocket opening 94 that provides an opening into the fork pocket 90. A first pivot connector 96 and a second pivot connector 98 connect a lid side wall 92 to the side wall 86 of the battery case 80. As previously described with reference to FIGS. 3-5, the pivot connectors may be individually removed or both removed to provide access to the top of the battery case 80.

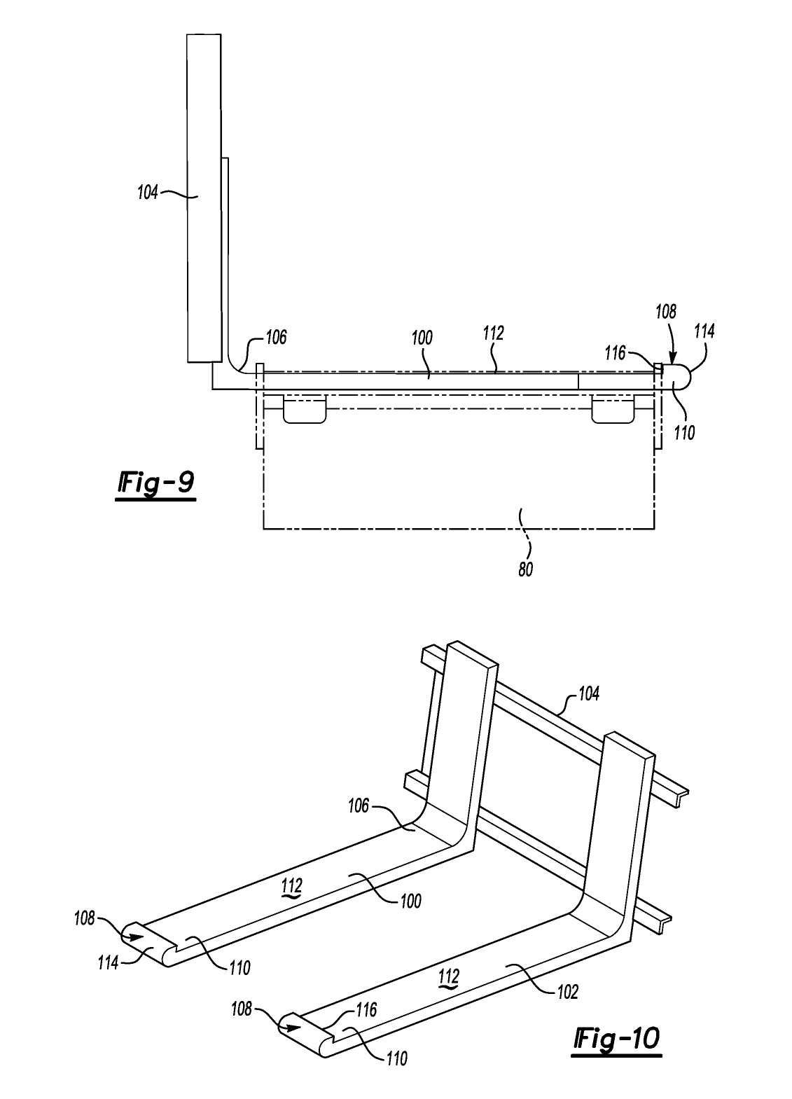

Referring to FIGS. 9 and 10, a right tine 100 and left tine 102 of industrial fork lift truck (not shown) are illustrated connected to a tine support structure 104. The tines 100, 102 each have a support end 106 that is adapted to be connected to the tine support structure 104. A stop 108 is provided on a distal end 110 of each of the tines 100, 102. The stop 108 extends upwardly from a top surface 112 of the tines 100, 102. The stop 108 includes a tapered end portion 114 that facilitates insertion of the tines 100, 102 into the fork pocket openings 60, 62. A vertical wall 116 is provided on the stop 118. The vertical wall 116 prevents the battery case 80 from sliding off of the tines 100, 102. The right and left tines 100, 102 are preferably slightly tapered from the support end 106 to the distal end 112 with the top surface 112 being disposed at a slight angle.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. An industrial truck battery assembly comprising:
a plurality of battery cells;
a housing for case that houses the plurality of battery cells and defines an upper opening; and
a lid defining at least one lift truck fork pocket assembled to the case and spanning the upper opening.

2. The battery assembly of claim 1 wherein the lid includes a first part and a second part and wherein the first part defines a first lift truck fork pocket and the second part defines a second lift truck fork pocket.

3. The battery assembly of claim 2 wherein the first part and the second part are fixedly connected to each other and are connected by a first pivot connector to a first side of the case and are connected by a second pivot connector to a second side of the case, wherein the first pivot connector and the second pivot connector are selectively removable from the first part and the second part to provide access to the battery cells through the upper opening.

4. The battery assembly of claim 3 wherein the first pivot connector is removable from the first part and the first side of the case, and wherein the lid is pivotable about the second pivot connector.

5. The battery assembly of claim 1 wherein the lid defines a plurality of ventilation holes that provide air flow to the batteries.

6. The battery assembly of claim 1 wherein the lift truck fork pocket defines a plurality of visual observation openings in a top wall of the lid.

7. A method of providing a plurality of battery assemblies on a trailer to a facility that uses battery assemblies for a plurality of industrial trucks, the method comprising:
charging the plurality of battery assemblies on the trailer at a remote location to provide charged battery assemblies;
delivering the trailer to the facility;
installing the charged battery assemblies on the trailer in the industrial trucks with a fork lift truck;
loading the trailer with discharged battery assemblies from the industrial trucks with the fork lift truck; and
transporting the discharged battery assemblies to the remote location.

8. The method of claim 7 wherein the remote location is an outdoor charging facility where the trailer takes the battery assemblies to be charged without removing the discharged battery assemblies from the trailer.

9. The method of claim 8 wherein the outdoor charging facility is a van trailer that houses a plurality of battery charges.

10. The method of claim 7 wherein the trailer includes a plurality of charging connectors with one charging connector being provided for each of the plurality of battery assemblies and a plurality of charging receptacle adapters being provided to connect each of the battery assemblies to a battery charging system.

11. The method of claim 10 wherein the battery charging system provides electrical energy from a power grid, and wherein electrical energy is alternatively provided by a power generator to back-up the power grid.

12. The method of claim 7 wherein during the installing step and the loading step the battery assemblies are disposed on the trailer in a single row, and wherein the fork truck can perform the installing step and the loading step from a right side of the trailer or a left side of the trailer.

13. The method of claim 12 wherein the trailer has a rack that is attached to the trailer for receiving the battery assemblies, wherein a width of the trailer and a width of the rack are substantially the same as a width of the battery assemblies.

14. The method of claim 13 wherein the rack has an upper set of battery receiving areas that receive a top row of battery assemblies and a lower set of battery receiving areas that receive a bottom row of battery assemblies.

15. The method of claim 14 wherein the upper set of battery receiving areas and a lower set of battery receiving areas each define a recess, and wherein the battery assemblies are constrained within the recess of the respective battery receiving areas.

16. The method of claim 7 wherein the battery assemblies include a housing that defines a fork pocket that extends through the housing, and wherein the fork lift truck has at least one tine that has a retainer lip on a distal end of the tine that is inserted fully through the fork pocket to retain the battery assembly on the tine.

17. A battery charging facility for charging a plurality of discharged battery assemblies for industrial trucks and material handling machines, wherein the battery assemblies are disposed on a trailer, the battery charging facility comprising:
a battery charger connected to a source of electrical power;
a dock having a first plurality of charger connectors;
a plurality of docking stations spaced along the dock for receiving the trailers and charging the discharged battery assemblies; and
a plurality of battery connectors electrically connectable to the plurality of discharged batteries on the trailer and electrically connected to the plurality of charger connectors.

18. The battery charging facility of claim 17 wherein the dock is located out-of-doors and the trailers when received at the docking station are also disposed out-of-doors.

19. The battery charging facility of claim 17 wherein the source of electrical power includes a power grid.

20. The battery charging facility of claim 17 wherein the source of electrical power includes a power generator.

21. A tine for a fork lift truck that has a battery assembly defining a fork pocket, the fork lift truck having a tine support structure, the tine comprising:
a support end that is adapted to be attached to the tine support structure; and
a distal end having a stop that extends upwardly from a top surface of the tine for retaining the battery assembly on the tine when the tine is inserted through the fork pocket of the battery assembly.

22. The tine of claim 21 wherein the stop includes a tapered end at the distal end of the tine and a vertical wall extending upwardly from the top surface of the tine and that faces the support end of the tine.

23. The tine of claim 21 wherein the tine is tapered in a vertical direction with a reduced thickness from the support end to the distal end.
